(19) United States
(12) Patent Application Publication
(10) Pub. No.: US 2019/0272506 A1
(43) Pub. Date: Sep. 5, 2019

(54) TRAVEL TRACKING SYSTEM AND METHOD OF USE

(71) Applicant: Mahesh Jaddangi, Collinsville, OK (US)

(72) Inventor: Mahesh Jaddangi, Collinsville, OK (US)

(21) Appl. No.: 16/290,378

(22) Filed: Mar. 1, 2019

Related U.S. Application Data
(60) Provisional application No. 62/637,016, filed on Mar. 1, 2018.

(51) Int. Cl. G06Q 10/10; G06Q 10/02; G06Q 50/30; G06Q 50/14; G06Q 50/12; G01C 21/36; G06N 20/00

(52) U.S. Cl. CPC G06Q 10/1093; G06Q 10/025; G06Q 50/30; G06N 20/00; G06Q 50/12; G01C 21/3691; G06Q 50/14

(57) ABSTRACT

A method of tracking travel time and providing a start time to a user includes receiving one or more travel itineraries from the user, the itineraries having travel data associated therewith; receiving data from artificial intelligence systems, the artificial intelligence systems being one or more of an airport travel system; a hotel booking system; and a vehicle renting system; receiving traffic data from a traffic data source; determining a travel time associated with the data from the artificial intelligence systems, the traffic data, and the one or more itineraries; and providing a start time for the travel time.

### BACKGROUND

### 1. Field of the Invention

The present invention relates generally to travel tracking systems, and more specifically, to a travel tracking system for updating a user with an accurate start time as well as providing notifications regarding delays and changes in itineraries regarding the travel.

### 2. Description of Related Art

Travel tracking systems are well known in the art and are effective means to provide maps and estimated travel times to users. For example, FIG. 1 depicts a conventional travel tracking system 101 having a user 103 using a mobile device 105 to access a mapping platform 107. During use, the mapping platform 107 receives traffic information 109 via a network 111 having one or more of a computer 113, a database 115, and a server 117. The traffic information 109 is used to update the travel time associate with mapping platform 107.

One of the problems commonly associated with system 101 is inaccurate start times for a trip. For example, when the user is driving to an airport, their mapping platform generally does not include information such as delayed flights, on time flights, security line waits, etc. Therefore, the user may arrive grossly early or too late.

Accordingly, there lies a need for a system that provides accurate travel and start times for trips through the use of data associated with all aspects of the trip.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified schematic of a common travel tracking system;

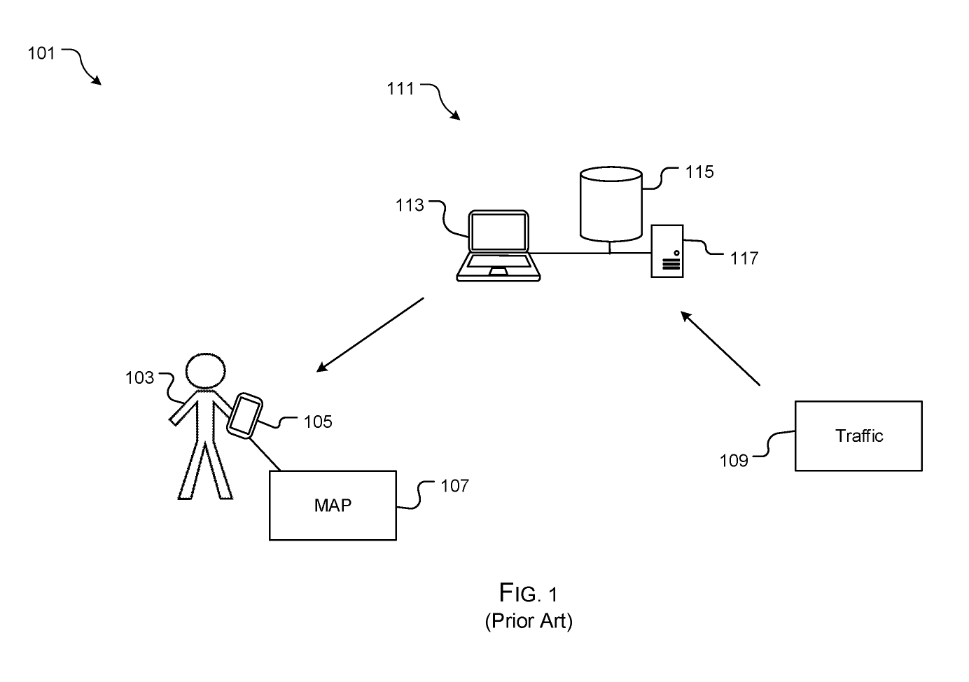

FIG. 2 is a simplified schematic of a travel tracking system in accordance with a preferred embodiment of the present application;

FIG. 3 is a simplified schematic of a travel platform of FIG. 2;

FIG. 4 is a simplified schematic of method of the system of FIG. 2; and

FIG. 5 is a flowchart of the method of use of the system of FIG. 2.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional travel tracking systems. Specifically, the present invention provides a means to improve accuracy associated with mapping, travel times, start times, and other information of a user's trip. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

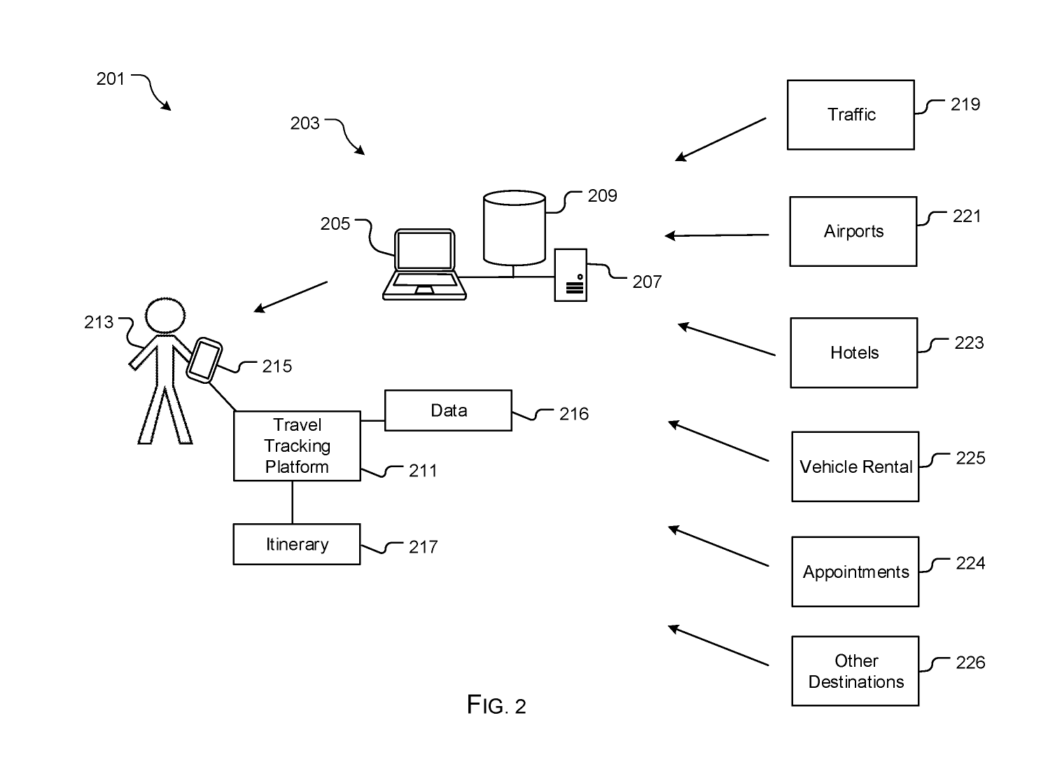

Referring now to the drawings wherein like reference characters identify corresponding or similar elements throughout the several views, FIG. 2 depicts a simplified schematic of a travel tracking system 201 in accordance with a preferred embodiment of the present application. It will be appreciated that system 201 overcomes one or more of the above-listed problems commonly associated with conventional travel tracking systems.

In the contemplated embodiment, system 201 includes a network 203 having one or more of a computer 205, a server 207, and a database 209, thereby being configured to receive, process, and transmit data and information between a plurality of sources and parties. System 201 further includes a travel tracking platform 211 configured to be accessed by a user 213 on a computing device 215, such as a computer, phone, or tablet.

In the preferred embodiment, platform 211 is configured to receive one or more itineraries 217, or other data 218, from the user, or from a plurality of sources known in the art. For example, the user can manually input itinerary information, such as a destination location, a preferred arrival time, a mode of transportation, way points, starting points, preferred routes, event starting times, etc. Further, it is contemplated that platform 211 can be configured to automatically retrieve data from other sources such as through the purchase of an airline or bus ticket, an electronic invitation, or other sources, thereby automatically receiving data associated with the trip, event, or travel destination.

In the preferred embodiment, platform 211 is configured to communicate with network 203 to receive data from a plurality of sources, including traffic data 219, airport data 221, hotel booking data 223, and vehicle rental agency data 225, appointment data 224, or any other destination data 226. It should be understood that platform 211 can be in communication with various computing devices, servers, and systems associated with each of the plurality of sources, thereby allowing for the data to be automatically transmitted and processed appropriately.

It should be appreciated that traffic data 219 can include data from third parties, such as accident locations, road work locations, heavy traffic, and the like. Airport data 221 can be received from artificial intelligence associated with one or more airports, and can include information such as flight delays, security line lengths, wait times, and the like. Similarly, hotel booking data 223 can be received from artificial intelligence associated with one or more hotels and can include rates, availability, location, and the like. Lastly, vehicle rental agency data 225 can be received from artificial intelligence and can include information such as wait times, vehicle availability, rates, and the like.

It should be appreciated that one of the unique features believed characteristic of the present application is the collection and processing of an abundance of data associated with a trip (or merely a travel to a destination or event) and using said data to provide the user with an accurate, recommended start time, which is updated in real time. It must be understood that all of the data received is processed to determine the best route, the estimated total time, and the best start time for the user, thereby saving valuable time when traveling and allowing the user to plan according to all present factors.

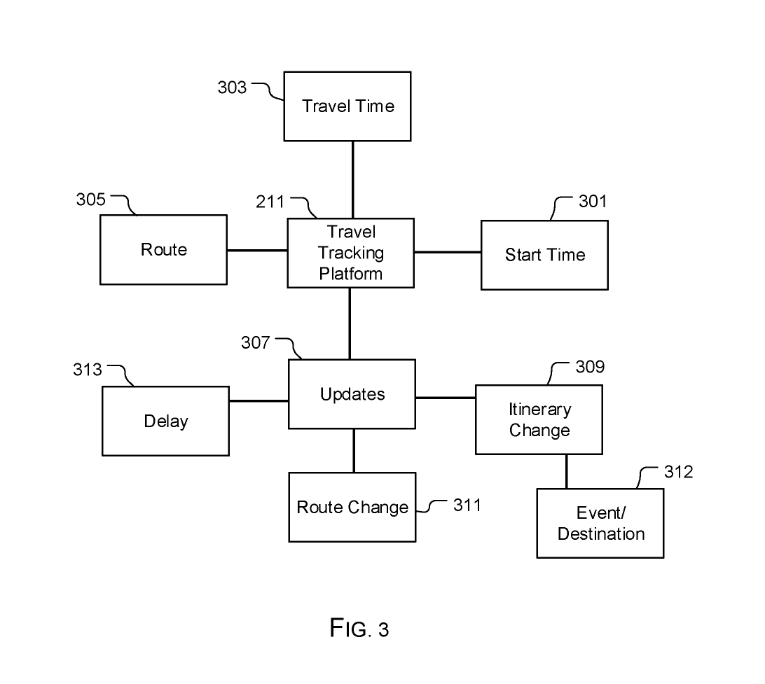

In FIG. 3, a simplified schematic shows various contemplated outputs of platform 211. Platform 211 provides the user with a recommended start time 301 and travel time 303, and provide updates accordingly. For example, based on data received, if the user should start sooner than their recommended time, they will receive a notification to do so, such as a push notification or SMS notice. Platform 211 further provides the user with a preferred route 305. Platform 211 is specifically programmed to provide the user with updates 307, such as through SMS or push notifications, the updates 307 being related to the trip, such as if an itinerary changes 309, a preferred route changes 311, or a delay 313 occurs. It should be appreciated that such updates could be related to a flight delay, a traffic accident, or similar activities. It must be understood that an itinerary change 309 can be a change in an event or destination 312 of any sort, such as a party, a doctor appointment, flights, or any other event.

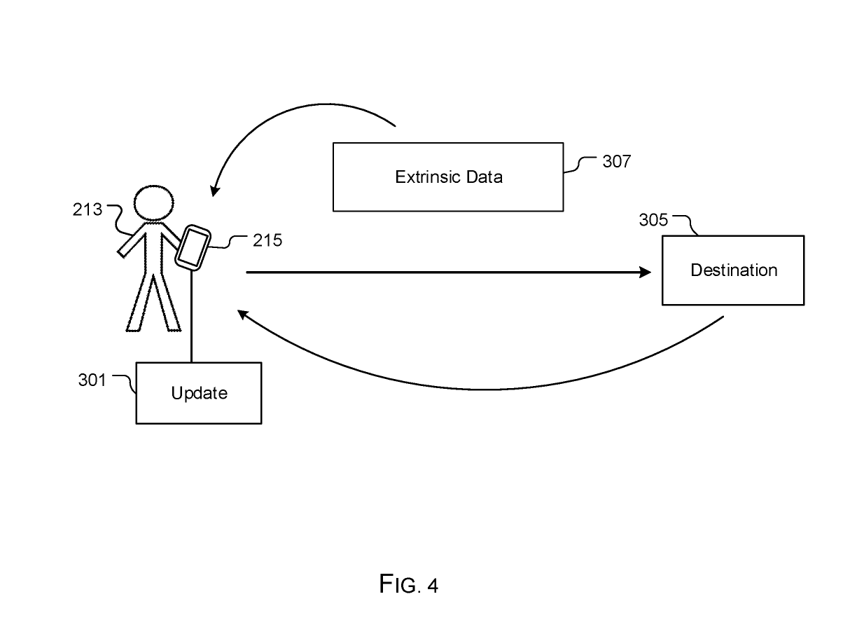

In FIG. 4, another simplified schematic demonstrates the process of the user 213 receiving an update 301 via device 215. As the user is planning for and beginning their trip to their destination 303, such as the airport, an appointment, an event, or any other destination, the extrinsic data 307, including delays, traffic, and the like, as well as data collected from the destination, such as flight delays, appointment cancellations, and the like, are collected and transmitted through the server to device 215 to provide the user 213 with real time updates 301 for the travel time and a necessary start time.

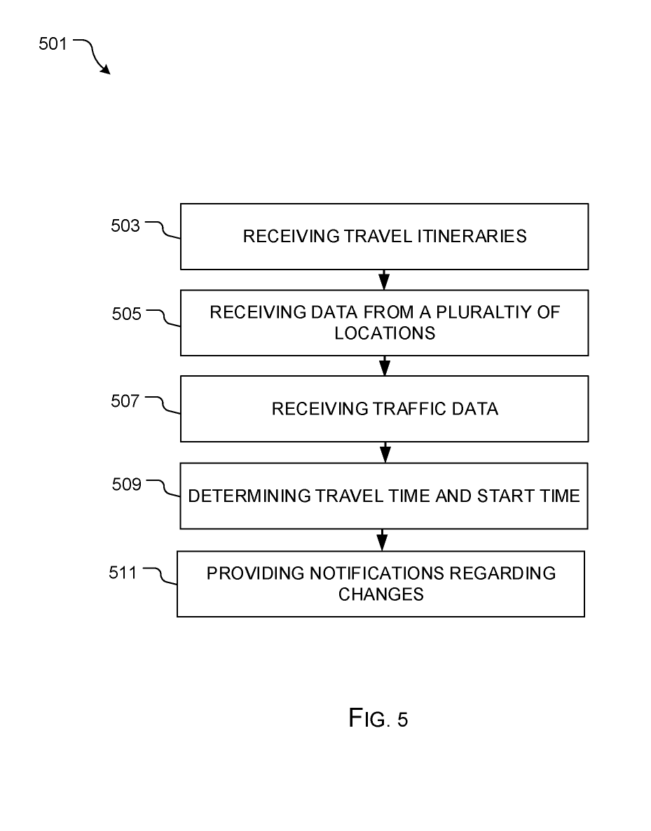

In FIG. 5, a flowchart 501 depicts a method of system 201. During use, one or more itineraries are inputted into the travel tracking platform, as shown with box 503. Data is received into the platform from a plurality of locations, such as airport systems, hotel systems, traffic data systems, and vehicle rental systems, as shown with boxes 505, 507. The user is provided with an estimated travel time and a preferred start time, as shown with box 509. As events happen, such as traffic delays, the user receives notifications from the platform, as shown with box 511.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A system for tracking travel times and providing travel updates, the system comprising:
a network having a server configured to receive and process data from a plurality of sources;
a platform configured to be accessed via a computing device and configured to communicate with the network, the platform in conjunction with the network configured to perform the steps of:
receive data from one or more itineraries from a user; and
receive data from a plurality of artificial intelligence sources;
wherein the data from the plurality of artificial intelligence sources and the data from the one or more itineraries is processed to determine a start time for travel;
wherein the platform is configured to provide notifications to a user regarding the start time.

2. The system of claim 1, wherein the plurality of artificial intelligence sources comprise one or more of:
an airport travel system;
a vehicle rental agency system;
a hotel reservation system;
a doctor appointment system; and
an event system.

3. The system of claim 1, wherein the platform is further configured to perform the steps of:
providing a notification regarding a delay associated with a travel time.

4. A method of tracking travel time and providing a start time to a user, the method comprising:
receiving one or more travel itineraries from the user, the itineraries having travel data associated therewith;
receiving data from a plurality of artificial intelligence systems, the plurality of artificial intelligence systems comprising one or more of an airport travel system; a hotel booking system; and a vehicle renting system;
receiving traffic data from a traffic data source;
determining a travel time associated with the data from the plurality of artificial intelligence systems, the traffic data, and the one or more itineraries; and
providing a start time for the travel time.

5. The method of claim 4, further comprising:
providing one or more notifications to the user through a computing device;
wherein the one or more notifications relate to one or more of a traffic problem; an itinerary delay; and a change in start time.
